(19) United States
(12) Patent Application Publication
(10) Pub. No.: US 2025/0012359 A1
(43) Pub. Date: Jan. 9, 2025

(54) RETRACTABLE SEALS FOR STRUCTURES

(71) Applicant: A&C FUTURE, INC., Newport Beach, CA (US)

(72) Inventors: Jiuqi Wang, Santa Ana, CA (US); Shoue CHEN, Irvine, CA (US); Sichen Li, Santa Ana, CA (US); Zhuangboyu Zhou, Santa Ana, CA (US); Yulai SHI, La Puente, CA (US); Ju Gao, Newport Beach, CA (US); Han Qin, Newport Beach, CA (US); Jiayang Qin, Newport Beach, CA (US)

(21) Appl. No.: 18/347,110

(22) Filed: Jul. 5, 2023

(51) Int. Cl. F16J 15/02; E04B 1/343; E04B 1/344

(52) U.S. Cl. CPC F16J 15/021; E04B 1/34305; E04B 1/344; B60P 3/34

(57) ABSTRACT

A sealing arrangement can be used to provide a seal between two adjacent structural elements, such as between two walls. The sealing arrangement may be particularly useful for expandable structures, such as expandable mobile homes, recreational vehicles, or the like. The sealing arrangement can include a first wall member that can provide a retractable seal that may extend outward from a face of the wall, toward a second wall member. The second wall member can include a door-covered opening along its end face that can receive the retractable seal from the first wall member. The second wall member may include upper and lower lids that automatically extend outward when the retractable seal is inserted into the opening. Air vents may be provided in the walls to provide air exchange.

### BACKGROUND OF THE INVENTION

### 1. Field of the Invention

Embodiments of the invention relate generally to seals. More particularly, embodiments of the invention relate to a retractable seal system that may be particularly useful for sealing between movable wall structures in an expandable home.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Expandable homes, including mobile homes and recreational vehicles (RVs) are popular options, as such are transportable along roads and can be set up at various sites. Many such homes include expansion sections, allowing the home to be set up on a location and expanded to provide living space that is often 150-300 percent larger than that of the home in the transportable, retracted state.

When such homes are expanded, often by sliding or folding arrangements, a seal is beneficial to prevent air and/or weather intrusion to the inside of the home.

In view of the foregoing, there is a need for a sealing arrangement for expandable structures.

### SUMMARY OF THE INVENTION

Embodiments of the present invention aim to solve the aforementioned problems in conventional structures by providing a retractable seal system that may be particularly useful for sealing between movable wall structures in an expandable home.

Embodiments of the present invention provide a structural panel having a scaling structure comprising a movable sleeve disposed along at least one side edge of the structural panel; an opening disposed vertically along one side of the movable sleeve; and a flexible seal material disposed inside the movable sleeve, wherein the movable sleeve is movable between an expanded configuration, where the flexible seal material is disposed within the movable sleeve, and a retracted configuration, where the flexible seal material extends outward from the opening in the movable sleeve; and when in the retracted configuration, the flexible seal material is operable to extend outward from the opening in the movable sleeve to engage with a second structural panel.

Embodiments of the present invention provide a sealing arrangement for structural elements comprising a first structural panel comprising a movable sleeve disposed along at least one side edge of the first structural panel, a first opening disposed vertically along one side of the movable sleeve, and a flexible seal material disposed inside the movable sleeve, wherein the movable sleeve is movable between an expanded configuration, where the flexible seal material is disposed within the movable sleeve, and a retracted configuration, where the flexible seal material extends outward from the first opening in the movable sleeve; and a second structural panel comprising an edge operable to sealing engage with the flexible seal material when the first structural panel is in the retracted configuration.

Embodiments of the present invention provide a sealing arrangement for wall panels comprising a first wall panel comprising a movable sleeve disposed along at least one side edge of the first wall panel, a first opening disposed vertically along one side of the movable sleeve, and a flexible seal material disposed inside the movable sleeve, wherein the movable sleeve is movable between an expanded configuration, where the flexible seal material is disposed within the movable sleeve, and a retracted configuration, where the flexible seal material extends outward from the first opening in the movable sleeve; and a second structural panel comprising a second opening formed along a side edge thereof, wherein the flexible seal material fits into the second opening to form a sealing engagement between the first structural panel and the second structural panel, a second door covering the second opening, the second door operable to pivot into an interior of the second opening and top and bottom lids extending outward from a top and bottom of the side edge of the second structural panel.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates an interior perspective view of two wall portions joined together with the seal arrangement according to an exemplary embodiment of the present invention;

FIG. 2 illustrates an exterior perspective view of the two wall portions of FIG. 1;

FIG. 3A illustrates a perspective view of a first wall element having a retractable seal, shown in the deployed state, according to an exemplary embodiment of the present invention;

FIG. 3B illustrates a detailed view take along circle 33 of FIG. 3A;

FIG. 4A illustrates a perspective view of a first wall element having a retractable seal, shown in the retracted state, according to an exemplary embodiment of the present invention;

FIG. 4B illustrates a detailed view take along circle 44 of FIG. 4A;

FIG. 5A illustrates a perspective view of a first wall element having a retractable seal, shown in the partially deployed state, according to an exemplary embodiment of the present invention;

FIG. 5B illustrates a detailed view take along circle 55 of FIG. 5A;

FIG. 6A illustrates an interior perspective view of a second wall element having an opening for receiving the retractable seal of FIG. 3A, shown in the closed state, according to an exemplary embodiment of the present invention;

FIG. 6B illustrates a detailed view take along circle 66 of FIG. 6A;

FIG. 7A illustrates an exterior perspective view of a second wall element having an opening for receiving the retractable seal of FIG. 3A, shown in the closed state, according to an exemplary embodiment of the present invention;

FIG. 7B illustrates a detailed view take along circle 77 of FIG. 7A;

FIG. 8A illustrates an interior perspective view of a second wall element having an opening for receiving the retractable seal of FIG. 3A, shown in a partially opened state, according to an exemplary embodiment of the present invention;

FIG. 8B illustrates a detailed view take along circle 88 of FIG. 8A;

FIG. 9A illustrates an interior side view of the first wall element, illustrating a rack and pinion feature, according to an exemplary embodiment of the present invention;

FIG. 9B illustrates a detailed view take along circle 99 of FIG. 9A; and

FIG. 10 illustrates a detailed view of the second wall element, illustrating a rack and pinion feature, according to an exemplary embodiment of the present invention.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a sealing arrangement that can be used to provide a seal between two adjacent structural elements, such as between two walls. The sealing arrangement may be particularly useful for expandable structures, such as expandable mobile homes, recreational vehicles, or the like. The sealing arrangement can include a first wall member that can provide a retractable seal that may extend outward from a face of the wall, toward a second wall member. The second wall member can include a door-covered opening along its end face that can receive the retractable seal from the first wall member. The second wall member may include upper and lower lids that automatically extend outward when the retractable seal is inserted into the opening. Air vents may be provided in the walls to provide air exchange.

As used herein, a wall panel may include interior and exterior sides. A thickness of the wall panel can be defined by its edges. Thus, an edge of the wall panel may be, for example, an outer surface of the wall panel that faces in a direction coplanar with a plane of the interior and exterior surfaces thereof. Therefore, as used herein, a side of the wall refers to the large interior or exterior surfaces thereof, while an edge may refer to the side edges of the wall panel.

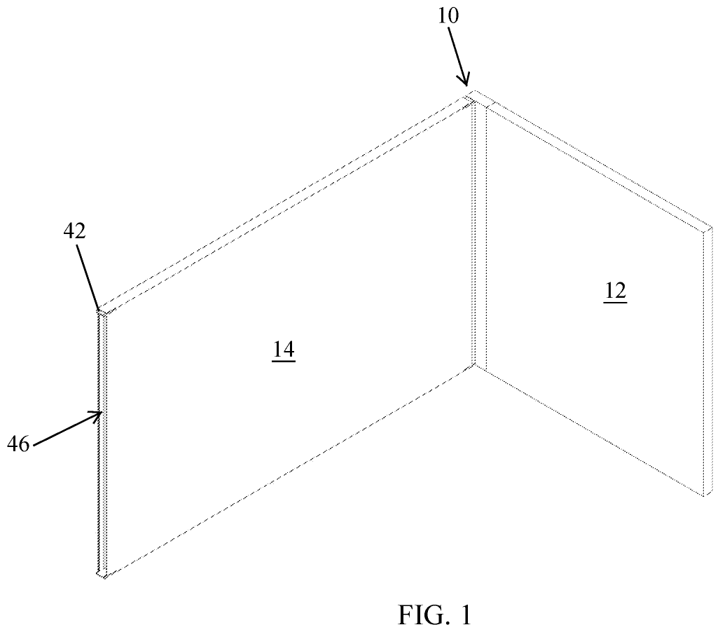

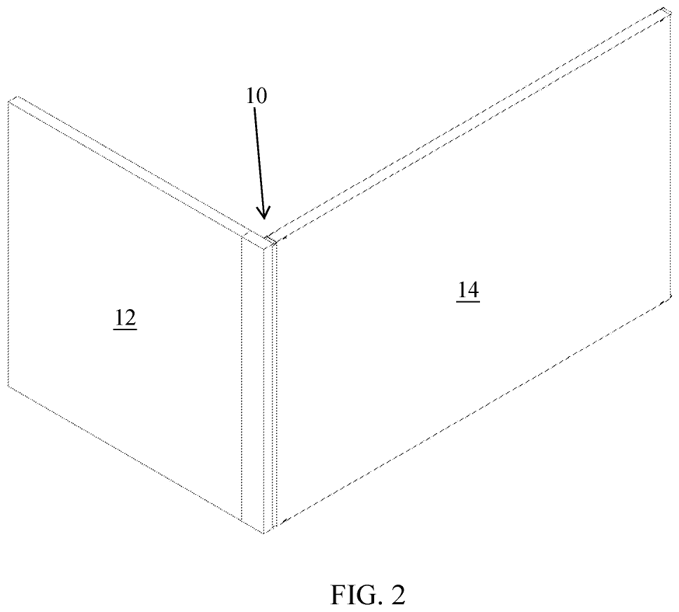

Referring to FIGS. 1 and 2, a sealing arrangement 10 is shown between a first wall 12 and a second wall 14. In some embodiments, the first wall 12 may be, for example, a folding wall that folds into a main structure (not shown) of an expandable home, and the second wall 14 may be a sliding end wall of the expandable home. Thus, the first wall 12 may pivot outward (along with a similar one of the first walls, opposite the first wall 12 shown in the figures), and the second wall 14 may slide outward. Then, the sealing arrangement 10 may operate, as described below, to provide a sealed engagement between the first wall 12 and the second wall 14.

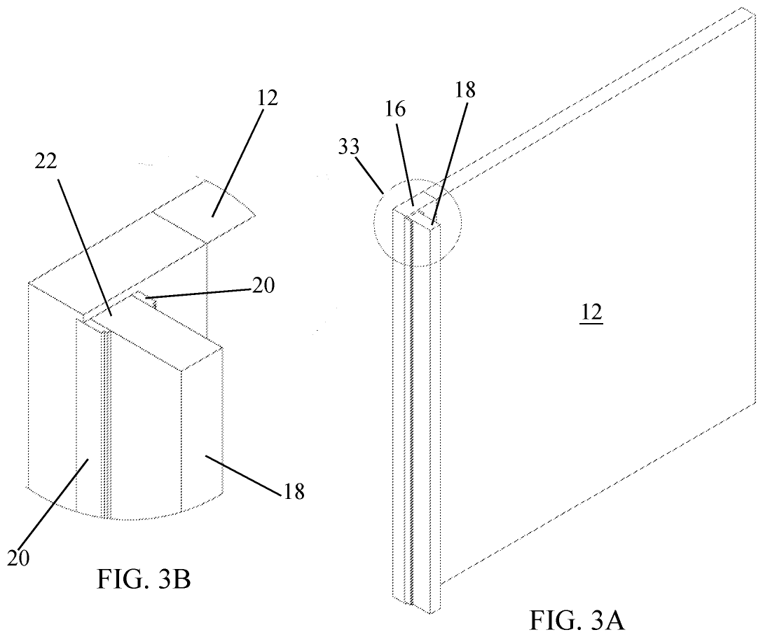

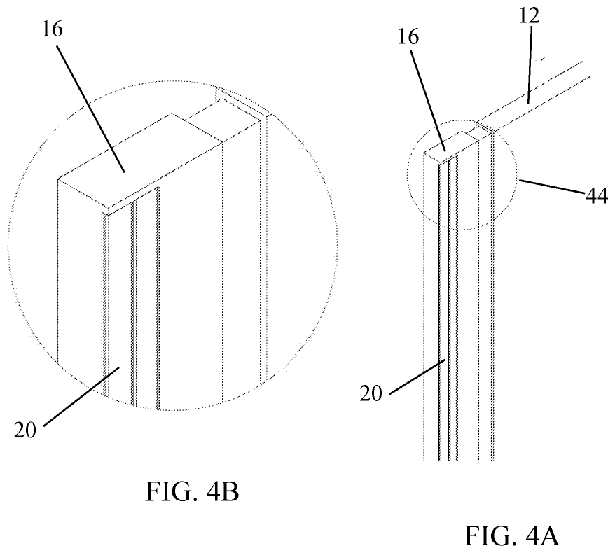

Referring now to FIGS. 3A through 5B, details of the first wall 12 are shown. In FIGS. 3A and 3B, a movable sleeve 16 is shown in the retracted position, with a flexible seal material 18 extending out of an opening 22 formed along vertical interior end of the first wall 12. Doors 20, that cover the opening 22 when the movable sleeve 16 is in the extended position (as shown in FIGS. 4A and 4B), can be opened to permit the flexible seal material 18 to exit the opening 22. In some embodiments, the doors 20 may be held closed resiliently with springs, for example. As described in greater detail below, the flexible seal material 18 may extend into an opening formed along an end of an adjacent wall (such as second wall 14).

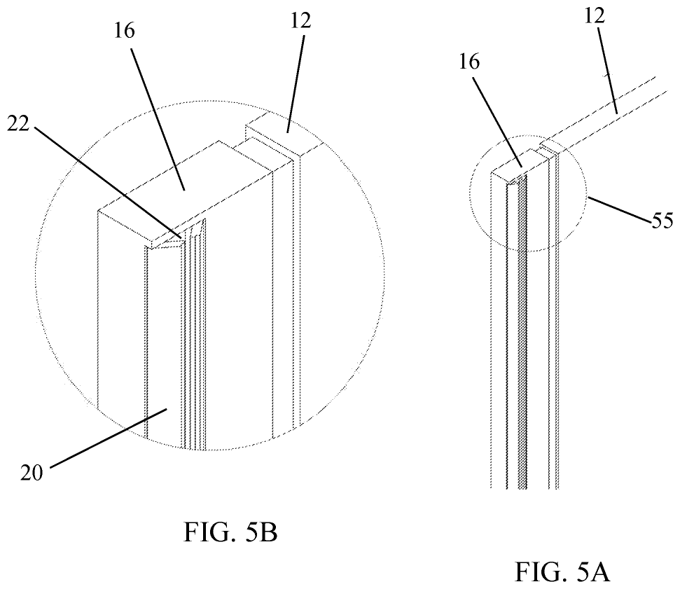

The movable sleeve 16 may be driven with a motor, as described below. Once the expansion section of a expandable home is formed, the motor may drive the movable sleeve 16 toward the main body of the movable wall 12. As the movable sleeve 16 is retracted, the flexible seal material 18, which is stored inside the movable sleeve 16 when fully extended (as shown in FIGS. 4A and 4B) may be pushed out of the opening 22 of the movable sleeve 16 to extend outward (as shown in FIGS. 5A, 5B. 3A and 3B) toward the end of the second wall 14 to create the sealing arrangement 10 as shown in FIGS. 1 and 2. The created seal between the first wall 12 and the second wall 14 can be formed without any bumps in the internal view of the walls 12, 14.

Typically, the opening 22 is directed in a direction orthogonal to the plane of interior surface of the first wall 12. Thus, the flexible seal material 18 can extend outward from the interior face or interior plane of the first wall 12. While the figures show the movable sleeve 16 at the end of the first wall 12, it should be understood that additional positions for the movable sleeve 16 may be possible. For example, an additional movable sleeve may be formed in a mid-section of the first wall 12. An additional second wall may move to align with this second position so that an interior partition wall may be formed with sealing between the first wall 12 and the interior partition wall (second wall 14).

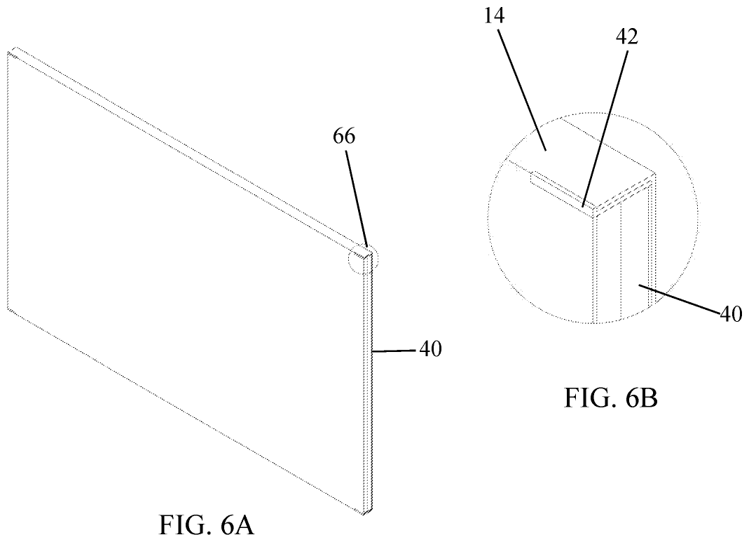

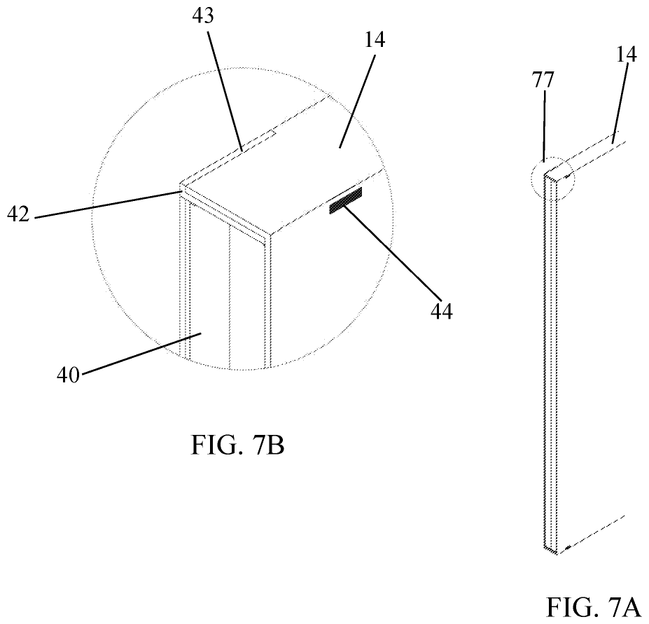

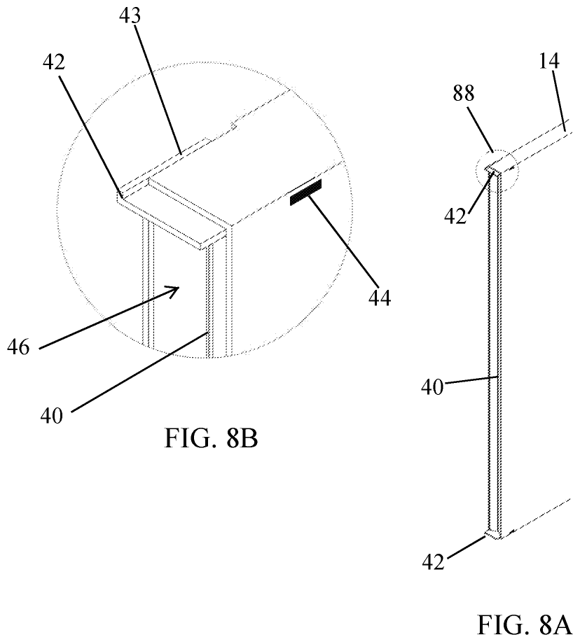

Referring now to FIGS. 6A through 8B, details of the second wall 14 are shown. The second wall can include doors 40 that provide access to an opening 46 formed along an end of the second wall 14. As the doors 40 are opened (for example, by a pressing action of the flexible seal material 18 of FIG. 3A extending out of the first wall 12), top and bottom lids 42 may extend outward to cover a top of the sealing arrangement 10 (see FIGS. 1 and 2). An extension arm 43 of the lids 42 may extend along an upper interior of the second wall 14, covering a vent opening 44 when the doors 40 are closed, and uncovering the vent opening 44 when the doors 40 are open and the top and bottom lids 42 are extending outward, as shown in FIGS. 8A and 8B. The vent opening 44 can provide air exchange between opposing sides of the second wall 14. In some embodiments, a filter element (not shown) may be disposed in the vent opening 44. In other embodiments, a fan (not shown) may be operated to assist in air exchange through the vent opening 44.

As can be seen in FIG. 1, the second wall 14 can include the opening 46 at both edges thereof. Thus, the second wall 14 can be sealed with two of the first walls 12.

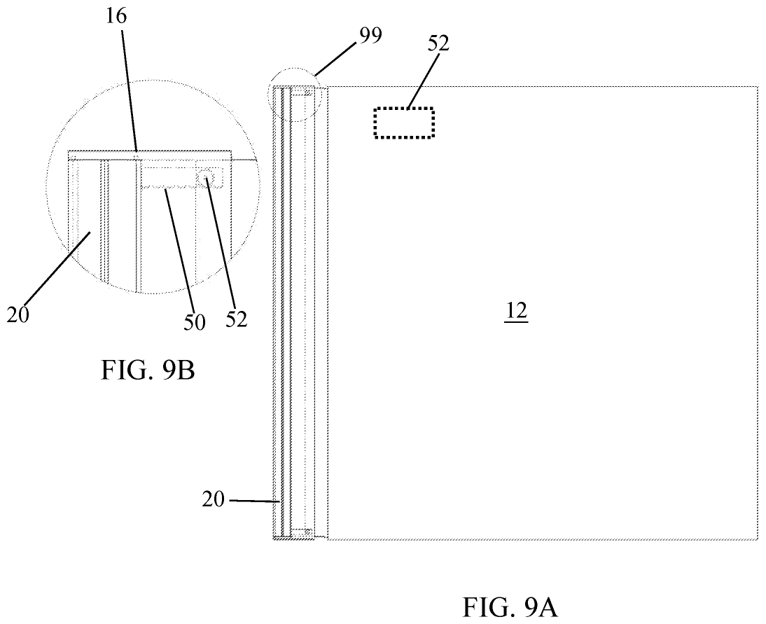

Referring to FIGS. 9A and 9B, in some embodiments, a rack and pinion mechanism may be used in the first wall 12. The rack 50 can be located on the movable sleeve 16 and the pinion 52 can be located on the main body of the first wall 12. The rack and pinion mechanism may be controlled by a motor 52. The rack and pinion mechanism can drive the movable sleeve 16 toward and away from the main body of the first wall 12, thus controlling the extension and retraction of the flexible seal material 18.

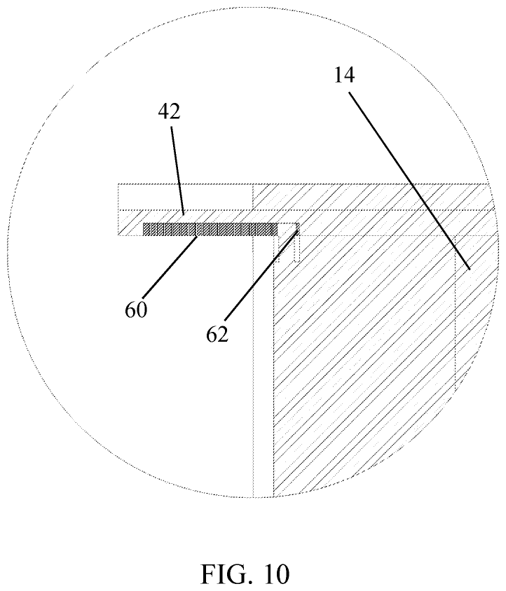

Referring to FIG. 10, a detailed view of the second wall 14 is shown, where a rack 60 and pinion 62 may be provided to automatically extend the top and bottom lids 42 when the doors 40 (not shown, see FIG. 6A) are opened. Thus, as the flexible seal material 18 is pressed into the doors 40, the doors 40 may open, causing the top and bottom lids 42 to extend outward at the same time. Of course, other mechanisms may be used for moving the top and bottom lids 42 within the scope of the present invention.

While the above describes a sealing arrangement between two adjacent walls formed at 90 degree angles, it should be understood that the structure described herein may be used for any structural elements were sealing therebetween may be helpful. For example, the sealing arrangement of the present invention may be useful for providing a seal between a movable wall and a floor member, for example.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A structural panel having a sealing structure comprising:
a movable sleeve disposed along at least one side edge of the structural panel;
an opening disposed vertically along one side of the movable sleeve; and
a flexible seal material disposed inside the movable sleeve, wherein:
the movable sleeve is movable between an expanded configuration, where the flexible seal material is disposed within the movable sleeve, and a retracted configuration, where the flexible seal material extends outward from the opening in the movable sleeve; and
when in the retracted configuration, the flexible seal material is operable to extend outward from the opening in the movable sleeve to engage with a second structural panel.

2. The structural panel of claim 1, further comprising doors operable to cover the opening when the movable sleeve is in the extended configuration.

3. The structural panel of claim 2, wherein the doors are resiliently held in a closed position.

4. The structural panel of claim 1, further comprising a rack and pinion mechanism operable to drive movement of the movable sleeve.

5. The structural panel of claim 4, further comprising a motor operable to move the rack and pinion mechanism to drive movement of the movable sleeve.

6. The structural panel of claim 1, wherein the doors, when opened when the movable sleeve is in the retracted configuration, are operable to interact with the second wall member.

7. The structural panel of claim 1, wherein the structural panel is a wall panel in an expandable home construction.

8. A sealing arrangement for structural elements, comprising:
a first structural panel comprising:
a movable sleeve disposed along at least one side edge of the first structural panel;
a first opening disposed vertically along one side of the movable sleeve; and
a flexible seal material disposed inside the movable sleeve, wherein:
the movable sleeve is movable between an expanded configuration,
where the flexible seal material is disposed within the movable sleeve, and a retracted configuration, where the flexible seal material extends outward from the first opening in the movable sleeve; and
a second structural panel comprising:
an edge operable to sealing engage with the flexible seal material when the first structural panel is in the retracted configuration.

9. The sealing arrangement of claim 8, wherein the first and second structural panels are first and second wall panels.

10. The sealing arrangement of claim 8, further comprising a first door operable to cover the first opening when the movable sleeve is in the extended configuration.

11. The sealing arrangement of claim 10, wherein the first door is resiliently held in a closed position.

12. The sealing arrangement of claim 8, further comprising a rack and pinion mechanism operable to drive movement of the movable sleeve.

13. The sealing arrangement of claim 12, further comprising a motor operable to move the rack and pinion mechanism to drive movement of the movable sleeve.

14. The sealing arrangement of claim 8, wherein the first door, when opened when the movable sleeve is in the retracted configuration, interacts with the second structural panel.

15. The sealing arrangement of claim 8, wherein the second structural panel includes a second opening formed along a side edge thereof, wherein the flexible seal material fits into the second opening to form a sealing engagement between the first structural panel and the second structural panel.

16. The sealing arrangement of claim 15, wherein a second door covers the second opening, the second door operable to pivot into an interior of the second opening.

17. The sealing arrangement of claim 16, wherein movement of the second door causes top and bottom lids extending outward from a top and bottom of the side edge of the second structural panel.

18. The sealing arrangement of claim 17, further comprising a rack and pinion mechanism to automatically extend the top and bottom lids when the second door is pivoted inward.

19. The sealing arrangement of claim 15, wherein the second opening is formed independently on opposite sides of the second structural panel.

20. A sealing arrangement for wall panels, comprising:
a first wall panel comprising:
a movable sleeve disposed along at least one side edge of the first wall panel;
a first opening disposed vertically along one side of the movable sleeve; and
a flexible seal material disposed inside the movable sleeve, wherein:
the movable sleeve is movable between an expanded configuration,
where the flexible seal material is disposed within the movable sleeve, and a retracted configuration, where the flexible seal material extends outward from the first opening in the movable sleeve; and
a second structural panel comprising:
a second opening formed along a side edge thereof, wherein the flexible seal material fits into the second opening to form a sealing engagement between the first structural panel and the second structural panel;
a second door covering the second opening, the second door operable to pivot into an interior of the second opening; and
top and bottom lids extending outward from a top and bottom of the side edge of the second structural panel.
